(19) United States
(12) Patent Application Publication
(10) Pub. No.: US 2006/0172172 A1
(43) Pub. Date: Aug. 3, 2006

(54) Hydrophilic bipolar plates

(76) Inventors: Tao Xie, Troy, MI (US); John N. Owens, Franklin, MI (US); Richard H. Blunk, Macomb Township, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/341,911

(22) Filed: Jan. 27, 2006

Related U.S. Application Data
(60) Provisional application No. 60/649,004, filed on Feb. 1, 2005.

(51) Int. Cl. H01M 8/02; H01B 1/24

(52) U.S. Cl. 429/34; 252/511

(57) ABSTRACT

A polymer composite bipolar plate for an electrochemical cell is formed with a hydrophilic surface. The thermosetting binder resin for the matrix of the composite preferably comprises aromatic groups or moieties and chemically resistant crosslinking bonds. After a mixture of binder resin precursors and conductive powder has been molded into a plate and thermally set, water-interactive chemical groups (i.e. ionic groups) are chemically attached to aromatic groups at the surface(s) of the plate to make the surface stably hydrophilic. For example, the surface of a styrene/divinyl benzene copolymer binder resin is sulfonated to make the surface hydrophilic.

### CROSS-REFERANCE TO RELATED APPLICATION

This application claims the benefit of U.S. Provisional Application 60/649,004, filed Feb. 1, 2005. The disclosure of that provisional application is incorporated herein by reference.

### TECHNICAL FIELD

This invention pertains to bipolar separator plates for electrochemical cells. More specifically this invention pertains to polymeric composite bipolar plates having durable hydrophilic surfaces for management of water flow in polymer electrolyte membrane (PEM) fuel cells.

### BACKGROUND OF THE INVENTION

Fuel cells are electrical power generating devices that have a stack of electrochemical cells connected to produce a specified electrical power level. In a fuel cell embodiment under widespread present development, a cation permeable, solid PEM, having protons (H+ ions) as the mobile ion, is employed in each cell. The electrolyte membrane separates a fuel gas stream containing hydrogen from an oxidant stream of oxygen or air. The overall cell reaction is the oxidation of hydrogen to water. The reaction at the anode side of the electrolyte membrane is H₂→2H⁺+2e and the reaction at the cathode side is ½ O₂+2H⁺+2e→H₂O. In a fuel cell with a plurality of cells, bipolar plates are interposed between the cells. The bipolar plates have opposing channeled surfaces respectively for delivery of hydrogen to the anode of one cell and for delivery of oxygen to the cathode of an adjoining cell.

Each bipolar plate serves as a current collector from the stack of cells and the plates must be electrically conductive. Also, water is removed from the cathode side of each bipolar plate and, therefore, the channeled surface of the plate must facilitate the flow of water.

Bipolar plates are sometimes made of stainless steel for its formability or machinability, electrical conductivity, and impermeability to hydrogen. But stainless steel is relatively heavy and it tends to corrode. Light weight polymeric composite materials such as graphite filled-vinyl ester resins have been proposed (of course, other resin chemistries are also used such as epoxies, phenolics, liquid crystalline polyesters, etc). They can be formulated to provide suitable formability, machinability, and electrical conductivity. But these materials are relatively or excessively hydrophobic and water does not readily flow over surfaces of such polymer composites. Thus, there is a need for a light weight, electrically conductive polymeric material with a durable hydrophilic surface for use as a bipolar plate in a water-producing fuel cell stack.

### SUMMARY OF THE INVENTION

An aromatic group-containing binder resin is provided for a polymeric composite bipolar plate that can be chemically treated to yield a stable hydrophilic surface. In accordance with a preferred embodiment of the invention, a mixture of styrene and divinyl benzene with a suitable radical initiator is mixed with a conductive powder, such as graphite and/or carbon black, and the mixture molded and heated to polymerize the thermosetting binder resin precursors. The divinyl benzene is used in an amount sufficient to crosslink the styrene based polymer chains. After polymerization, surfaces of the molded bipolar plate are treated with a sulfonating agent to attach sulfonate groups to exposed polymer molecules at the surface of the plate. These sulfonate groups are strongly attached via covalent bonding to benzene rings regularly occurring in the styrene/divinyl benzene co-polymer to provide suitable water interactive sites that render the surface hydrophilic and stably hydrophilic.

Thus, the generic concept of the invention is to provide an aromatic group-containing and thermosetting binder resin for an electrically conductive polymer composite that forms a durable, electrically conductive, hydrogen impermeable bipolar plate for an electrochemical cell. The binder resin is formed of aromatic group-containing monomer units, such as styrene and divinyl benzene, so that the surface of a molded bipolar plate can be treated to contain ionic groups that render the surface suitably hydrophilic. The polymerized binder resin contains regularly distributed chemically functional groups or moieties so that sulfonate groups or other hydrophilic ionic groups can be formed on the surface of the plate after molding to provide the bipolar plate with stable hydrophilic surfaces. The precursors of the resin, which include aromatic groups, are mixed with solid conductive material, polymerization catalyzing and/or promoting agents, and other suitable additives for molding of the plate and/or the physical and electrical properties of the polymer composite.

In accordance with a preferred embodiment of the invention, polymer molecules at the surface of the conductive composite are provided with ionic groups that render the surface hydrophilic and, importantly, stably hydrophilic under environmental conditions ranging from dry to wet. Examples of such ions are SO₃⁻ anions and H⁺ cations attached by sulfonation of the divinyl benzene/styrene based polymer surface. Concentrated sulfuric acid is an example of a suitable sulfonating agent for divinyl benzene-styrene based polymer composite surfaces and other suitable polymer surfaces. Polymer composite surfaces are suitably sulfonated by contact with concentrated sulfuric acid at, for example, 90° C. But the sulfonation can be accomplished with sulfuric acid under milder conditions and/or with other sulfonating agents.

Other objects and advantages of the invention will be apparent from a description of preferred embodiments.

### BRIEF DESCRIPTION OF THE DRAWINGS

FIG. 1 is a graph of contact angle (degrees) versus baking time in hours for a conductive polymer composite based on a sulfonated divinyl benzene-styrene resin. This graph shows that the hydrophilicity of the composite is retained after both wet and dry baking tests.

FIG. 2 is a graph of contact angle (degrees) versus baking time in hours for a prior art conductive polymer composite based on a sulfuric acid treated vinyl ester resin. This graph shows loss in the hydrophilicity of the composite during both wet and dry baking tests.

FIG. 3 is a graph of flex strength (ksi) versus etching time (with concentrated sulfuric acid) in minutes. This graph shows the loss in physical properties of a prior art conductive polymer composite based on a vinyl ester resin when etched with sulfuric acid to render its surface hydrophilic.

FIG. 4 is an enlarged cross-sectional view of a molded polymer composite bipolar plate or separator plate for a fuel cell.

### DESCRIPTION OF PREFERRED EMBODIMENTS

Molded polymer composite bipolar plates for hydrogen fuel cells are molded to be as thin as possible without cracking of the parts. Usually the plates are no greater than about three millimeters in thickness. Channels for the flow of hydrogen are molded or machined in one side of the molded plate and channels for air or oxygen formed in the other side of the plate. In accordance with this invention the shape of the plate is not critical. But the channels on both sides of the plate must display suitable hydrophilicity for the flow of water.

FIG. 4 illustrates a polymer composite bipolar plate 10 in cross-section. Bipolar plate 10 has opposing surfaces 12 and 14 preferably spaced no more than about three millimeters. Surfaces 12 and 14 each have molded or machined channels 16 for the flow of fluids. One of the sides faces the cathode of one cell and the other side of plate 10 faces the anode of an adjacent cell of a fuel cell stack. Channels 16 are illustrated as being semi-circular in cross-section but they sometimes have “rectangular” sides and bottoms. Surfaces 12 and 14 and channels 16 are prepared to be hydrophilic in accordance with this invention.

As stated in the background section of this specification, bipolar plates for hydrogen fueled electrochemical cells must be wettable by water. When a drop of water is placed on a surface, wettability is assessed by the contact angle between the droplet and the surface. A composite plate surface (plate surfaces 12 and 14, and the surfaces of channels 16) with a contact angle of less than 45 degrees is the target.

The 45 degrees is based on channel geometry and the so-called Concus-Finn condition: beta+alpha/2<90 degrees; where beta is the static contact angle and alpha is the channel (16) corner angle. If the plate material is sufficiently wettable, water transported through the diffusion medium thickness will contact the channel wall and then, via capillary forces, be transported in the bottom corners of the channel along its length. The physical requirements to support spontaneous wetting in the corners of a channel are given by the equation above. For a rectangular channel (alpha/2=45 degrees), spontaneous wetting will occur when the static contact angle is less than 45 degrees.

Water also needs to be removed from the anode flow field channels (H₂ fuel is humidified externally to saturate polymer ionomer to decrease protonic resistance) and water diffuses from the cathode side to the anode side. The formation of water “slugs” in either the anode or cathode flow field channels restricts flow of reactant gases (H₂ and air) and the flow is diverted to low resistance channels of the same cell that do not contain water slugs. The catalyst in these gas-starved areas is not utilized and cell potential decreases. Eventually, the flow resistance of the cells containing the water slugs increases to a high enough level that all the flow is diverted to neighboring cells; as a result, the wet cells become low performance cells with potentials approaching zero. A hydrophilic plate surface eliminates low performance cells because the generated water spreads as a thin film in the channels and does not block the entire cross-sectional area of the channel (i.e., a water slug is not generated). The thin film of water is then sheared out of the channels by the flowing reactant gases and/or due to capillary motion in the wetted, narrow channels.

In accordance with this invention a molded polymer composite bipolar plate is provided with durable and stable hydrophilic surfaces.

Molding Compound Formulation:

A thermosetting resin based primarily on a combination of divinyl benzene (DVB) and styrene is preferred. Although a 60% (by weight) DVB, 40% styrene mixture was used, the exact ratio of DVB to styrene is not critical. Enough DVB must be used to increase the cross-link density for the desired thermal stability properties. A small level of vinyl ester resin can be added to the mixture but the percentage must be limited in order to maintain chemical resistance to the following sulfuric acid etching step.

The thermosetting resin is cured via a free-radical mechanism. Although many catalysts are available that generate free-radicals, the use of organic peroxides is preferred. Organic peroxides such as methyl ethyl ketone peroxide, benzoyl peroxide, or members of the peroxyketal family are typical choices.

In order to meet the electrical conductivity targets for the final molded bipolar plate, a high loading of graphite (possibly carbon black as well) fillers is used. The graphite fillers can be natural graphite, synthetic graphite or expanded graphite. The key is to get a percolated network of conductive fillers into the molding compound to enable high electrical and thermal conductivity. The filler loading level necessary to achieve a percolated network can be as low as 25% or as high as 90% depending on the size and aspect ratio of the graphite chosen. Most typically, the use of between 70 and 80% by weight graphite is suitable for the practice of the invention. The graphite filler package may include short carbon fibers if a higher strength plate material is required.

Molding and Surface Sulfonation

A monomer mixture of sixty percent by weight divinyl benzene and forty percent by weight styrene was prepared. Fine particles of graphite were mixed with the monomer mixture to an amount of about seventy parts per hundred parts total resin. A small amount of methyl ethyl ketone peroxide radical initiator catalyst was mixed with the graphite filled resin mixture. The mixture was molded into thin plates using a steel plaque tool pre-heated to 150° C. Molding time was approximately ten minutes. The surfaces of the polymerized plates were sulfonated in concentrated sulfuric acid for ten minutes at 90° C. Other sulfonating conditions with sulfuric acid could have been used. And other sulfonating agents or stable ionic group incorporating agents could have been used.

The sulfonated plates were then tested for wettability with water and other physical properties.

Testing:

The DVB/Styrene resin chemistry allows polar groups (sulfuric acid groups in this case) to be introduced onto the aromatic rings on the polymer chains without damaging the cross-links. As a result, the sulfuric acid treated composite coupons showed significant hydrophilic stability. Bipolar plates in operating fuel cells can experience conditions ranging from very wet to quite dry. Accordingly, the treated composite coupons were subjected to two baking tests to evaluate the stability of their hydrophilicity. In one test (called the dry or D-test) the composite coupons were baked at 90° C. at a relative humidity of less than 5%. In the other test the specimens were soaked in hot water at 90° C. (called the wet or W-test). The dry test condition for hydrophilic stability in bipolar cells is quite important. Under low relative humidity conditions, high-energy (hydrophilic) surfaces are more susceptible to contaminants originating internally from the bulk composite material (e.g., internal mold releases and other low molecular weight hydrophobic oligomers/particles). The surfaces are also susceptible to contaminants originating externally from the air/fuel environment (e.g., fuel cell stack/module). It is preferred that a water film continually occupies surface sites on each bipolar plate and prevents the surface from being contaminated with low energy substances. In addition, electrically-charged contaminant particles in the air/fuel environment are less attracted to wet surfaces because water is somewhat conductive and dissipates charge buildup on charged surfaces.

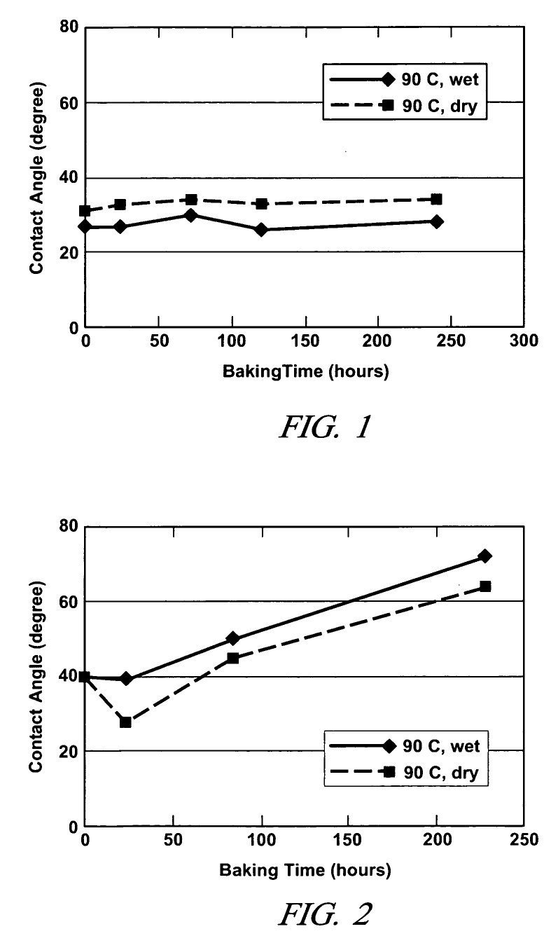

As can be seen in the graph of FIG. 1, the contact angles of the sulfonated divinyl benzene-styrene polymer composites of this invention remain virtually unchanged after wet and dry baking tests. As also expected, the acid treatment did not induce roughness change on the surface, indicating no material dissolution and thus no mechanical properties loss.

Comparative Tests with Prior Art Bipolar Plate Polymer Composite Materials

Vinyl ester graphite filled polymer composites have been proposed for fuel cell bipolar plate applications. For purpose of comparison with the above test data, conventional vinyl ester graphite filled composite (1 mm in thickness) was immersed into concentrated sulfuric acid at 70-90° C. for a specified period of time (1-15 minutes), and rinsed several times with deionized water. The sulfuric acid etching process introduced hydrophilicity onto the composite surfaces. Typically, water droplets spread on these samples, as a result, initial contact angles were measured immediately after the droplets reached the surfaces and used to evaluate the surface hydrophilicity. The treated vinyl ester based composite coupons were subjected to the dry and wet baking tests described above. As an example, 3 min etching at 80° C. resulted in contact angle of 40, versus 80 before the treatment. However, upon the stability test, the surfaces experienced hydrophilicity loss, as shown in FIG. 2.

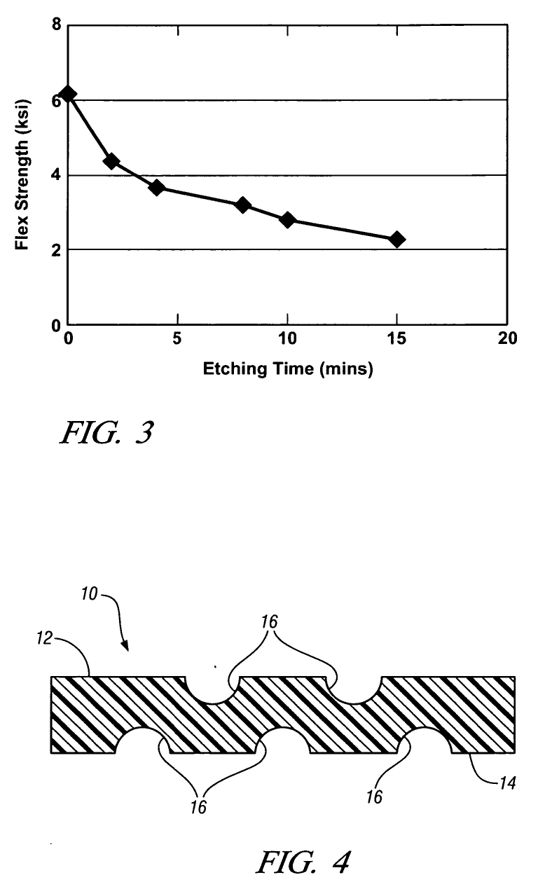

It was also discovered that an undesirable consequence associated with the sulfuric acid etching, which is the loss of mechanical strength. As shown in FIG. 3, the acid etching resulted in significant loss in flex strength. It is believed that loss of flex strength is due to the dissolution of materials during the acid etching, as implied by the roughened surfaces observed after the treatment. Although some level of surface roughening is desirable because it improves the contact resistance by removing a resin-rich surface layer, it has to be balanced with mechanical property loss.

It is believed that both the hydrophilicity and mechanical property losses in the vinyl ester based composites were due to the cleavage of the polymer chains during the acid etching. The vinyl ester functional group is particularly vulnerable towards acid attack. As a result, the essential cross-linking for maintaining stable hydrophilicity and mechanical property was destroyed.

The stability or durability of the hydrophilic property of a polymer composite bipolar plate is important to successful prolonged operation of the fuel cell. For example, portions of a composite plate may experience prolonged exposure to hot dry conditions. In such conditions, constituents of composite material may migrate to the surface and accumulate there, adversely affecting the function of the bipolar plate provided by a hydrophilic surface. Or, other contaminants in the cell may accumulate on a dry composite plate surface and make it more hydrophobic. Tests have been performed that reveal that the sulfonated composites of this invention with ionic groups retain their hydrophilicity in a hot dry environment while other polymer composites with less stable hydrophilic surfaces become hydrophobic in the dry conditions. Plaques or slides of the following materials were prepared to have hydrophilic surfaces for aging at 90° C. and relative humidity equal to or less than 5%: (1) a sulfonated divinyl benzene (DVB)/styrene composite of this invention, (2) a commercial vinyl ester composite coated with SiO₂, (3) a chromic acid-etched vinyl ester composite, (4) a HF-etched glass slide, and (5) a KOH film deposited glass slide. A drop of water was placed on the surface of each plaque or slide and the initial contact angle measured. The respective samples were then aged in a dry oven at the stated conditions. After various test times specified in the following table, the specimens were removed and again tested for surface hydrophilic properties by measurement of the contact angle of a drop of water places on their respective surfaces.

| | | | Aging Time at |
|---|---|---|---|
| | Initial Contact | Final Contact | 90 C./1% RH |
| Sample | Angle (degrees) | Angle (degrees) | (weeks) |
| Sulfonated | 25 to 35 | 25 to 35 | 6 |
| composite | | | |
| SiO2-coated | <10 | 130 to 140 | 2 |
| composite | | | |
| Chromic acid | <10 | 70 to 80 | 2 |
| etched composite | | | |
| HF-etched glass | <10 | 50 to 60 | 0.5 |
| slide (VWR) | | | |
| KOH film on | 0 | 0 | 3 |
| glass slide | | | |

The data summarized in the above table demonstrate that the sulfonated polymer composite of this invention with its stable surface ionic groups displayed initial hydrophilic properties which were retained during six weeks of aging under hot dry conditions. However, when the vinyl ester composite was coated with silica its initial hydrophilic character was destroyed during only two weeks exposure at the hot dry condition. The SiO₂-coated composite sample contained a thin, discontinuous layer of glass (only about 70 nm thick) so that it remained electrically conductive, but it still became more hydrophobic on ageing apparently due to contamination of the surface. Similarly, the chromic acid etched-vinyl ester polymer composite plaque lost its hydrophilic surface character during the dry test procedure. The HF-etched glass slide data suggest that air contaminants from the oven increased its contact angle because the glass contained no bulk contaminants. Finally, the highly ionic KOH film on glass retained its hydrophilic character. Such a material is not suitable for a bipolar plate but the experiment demonstrates the utility of stable surface ions for retaining a hydrophilic surface.

Thus, the presence of stable ionic groups on the surface of a polymer composite maintains a desirable hydrophilic surface. Such a surface assures that water can wet and flow in channels in the bipolar plate, and the presence of the stable ions make the surface less susceptible to contamination effects that reduce hydrophilicity. Accordingly, it is seen that very useful benefits of retained mechanical strength and hydrophilicity are realized in the ionic group containing divinyl benzene-styrene based polymer composite bipolar plates of this invention.

In the embodiments of the invention illustrated above, stable hydrophilic surfaces of divinyl benzenes-styrene polymer composites were formed by sulfonation. Ionic species, such as SO₃⁻ and H⁺, are formed which, as demonstrated above, made the polymeric surface hydrophilic in a manner that retained its wettable character over a wide range of environmental conditions. Other chemical agents for forming durable ionic groups on a polymeric surface can be used with or in place of sulfonating agents.

The invention is not limited to the illustrated embodiments.

1. A bipolar plate with at least one hydrophilic surface for use in an electrochemical cell, the bipolar plate being molded from a cross-linkable resin precursor mixture comprising aromatic groups, the resin precursor mixture also containing inter-connecting electrically conductive powder particles; and the at least one surface of the molded plate being made stably hydrophilic by ionic groups chemically attached to aromatic groups after molding of the resin, the cross-linked character of the molded resin being retained.

2. A bipolar plate as recited in claim 1 in which at least one surface of the molded plate contains sufficient chemically attached ionic groups to resist loss in hydrophilicity of the surface of the plate during exposure to contaminants at low relative humidity conditions.

3. A bipolar plate as recited in claim 1 in which the cross-linkable resin precursor mixture comprises styrene and divinyl benzene.

4. A bipolar plate as recited in claim 1 with a surface of the molded plate is made stably hydrophilic by attachment of sulfonate groups to aromatic groups.

5. A bipolar plate as recited in claim 3 in which aromatic groups have been sulfonated by treatment of a surface of the molded plate with sulfuric acid.

6. A bipolar plate with at least one hydrophilic surface for use in an electrochemical cell, the bipolar plate being molded from a cross-linkable resin precursor mixture comprising aromatic groups including vinyl benzene groups, the resin precursor mixture also comprising inter-connecting conductive powder particles; and the at least one surface of the molded plate being made stably hydrophilic by ionic groups chemically attached to aromatic groups after molding of the resin, the cross-linked character of the molded resin being retained.

7. A bipolar plate as recited in claim 6 in which the cross-linkable resin precursor mixture comprises styrene and divinyl benzene.

8. A bipolar plate as recited in claim 6 in which aromatic groups have been sulfonated by treatment of the at least one surface of the molded plate with sulfuric acid.

9. A bipolar plate as recited in claim 7 in which aromatic groups have been sulfonated by treatment of the at least one surface of the molded plate with sulfuric acid.
